(19) United States
(12) Patent Application Publication
(10) Pub. No.: US 2007/0028041 A1
(43) Pub. Date: Feb. 1, 2007

(54) Extended failure analysis in RAID environments

(75) Inventors: Basavaraj Hallyal, Fremont, CA (US); Senthil Murugan Thangaraj, Fremont, CA (US); Ragendra K. Mishra, Fremont, CA (US)

Correspondence Address: LSI LOGIC CORPORATION, 1621 BARBER LANE, MS: D-106, MILPITAS, CA, 95035, US

(73) Assignee: LSI Logic Corporation

(21) Appl. No.: 11/190,782

(22) Filed: Jul. 26, 2005

(51) Int. Cl. G06F 12/16

(52) U.S. Cl. 711/114

(57) ABSTRACT

Systems, apparatuses, and methods are described for performing diagnostic testing in a RAID environment in response to a failed memory access request to determine if a hard drive within the RAID failed.

### BACKGROUND

A. Technical Field

The present invention relates generally to storage technology, and more particularly, to performing diagnostic testing in a Redundant Array of Independent Disks (RAID) environment.

B. Background of the Invention

As the use of technology in daily life continues to increase, there is an increased amount of digital data that must be stored. Most data is currently stored on hard drives that have large amounts of storage space. As the size of the hard drives and the amount of data increases, technologies for quickly accessing the data become very important. In addition, as the information stored on hard drives becomes more valuable and important to the user, backing up the data in case of a failure, also referred to as fault protection, becomes increasingly important. One technology that is commonly used to improve performance and/or provide fault tolerance is a technology called RAID, which stands for a Redundant Array of Independent Disks.

A RAID is a system that typically includes a RAID controller and two or more hard disks that make up a RAID array. The RAID controller interfaces with the hard drives in the array and handles the performance and fault tolerance features. Performance is improved by disk striping, which interleaves one or more bytes of data across multiple hard drives. This feature distributes the reading or writing of data across multiple hard drives, thereby improving the read/write capabilities of the system. Fault tolerance is improved by either mirroring or parity. Mirroring involves storing the same data on multiple hard drives, thus maintaining two complete copies of the data. Parity involves XORing a bit from a first hard with the same bit in a second hard drive and storing the result in a third hard drive. If the first or second drive fails, the data in that drive can be recreated using the data from the remaining drive and the third hard drive, which stores the parity data. RAID arrays can be set up to provide fault tolerance, improved performance, or a combination of the two.

FIG. 1 illustrates an example of a Small Computer System Interface (SCSI) RAID environment 100. As illustrated, RAID environment 100 includes a RAID controller 110 and an enclosure 170 that houses a SCSI enclosure services (SES) device 140, a power supply 150 and a cooling element 160. The enclosure also houses a plurality of hard drives 120A-n, where n varies depending on how many hard drives are supported by the RAID controller. In a SCSI environment, a RAID controller can support up to 15 hard drives. However, in an IDE RAID environment, the RAID controller may only be able to support up to 4 hard drives.

RAID controller 110 is connected to hard drives 120A-n through a bus. In this example, a SCSI cable 130 is used to connect RAID controller 110 to hard drives 120. The SCSI cable 130 also connects the RAID controller 110 to the SES device 140. In turn, SES device 140 is coupled to a power supply 150 and a cooling element 160.

Power supply 150 provides power to the SES device 140, hard drives 120A-n and cooling element 160. Cooling element 160 regulates the temperature within enclosure 170. SES device 140 may interface with power supply 150 and cooling element 160 using SES commands to manage and sense the state of power supply 150 and cooling element 160. RAID controller 110 may interface with SES device 140 to manage and obtain information about power supply 150 and cooling element 160.

RAID controller 110 typically interfaces with a central processing unit (CPU), not shown, of a computer or other device that wishes to issue memory access requests, such as read and write operations, to the hard drives 120. The RAID controller issues such requests to the hard drives 120 while handling the performance and fault tolerance features of the RAID.

Occasionally, hard drives experience some form of malfunction that prevents the drive from performing a memory access request. In current RAID environments, when a memory access request is issued to a hard drive(s) 120, the hard drive(s) 120 has a predetermined amount of time in which to respond to the RAID controller indicating that the memory access request completed successfully. If the hard drive does not respond within this predetermined amount of time, a timeout condition occurs and the RAID controller will recognize that there is a problem.

In the current state of the art, the RAID controller will change the status of the hard drive to FAILED. A failed hard drive is pulled from the RAID array and replaced with a new hard drive. The failed drive is typically sent to the manufacturer to determine the cause of the failure. However, often times, the manufacturer does not find a problem with the drive. There are a number of reasons that a memory access request might fail that are unrelated to a failed hard drive. For example, a broken cable connected to the hard drive or some other hardware failure between the RAID controller and the hard drive may have resulted in the failed memory access request. Or, environmental conditions, such as excessive heat within the enclosure housing the hard drive or excessive vibration in the mounting of the hard drive may result in a temporary inability for the hard drive to perform the memory access request.

Such problems are not caused by a failed hard drive. However, in the current state of the art, any timeout condition typically results in the hard drive being pulled from the RAID array and sent back to the manufacturer. Since not all timeouts are caused by a hard drive failure, this results in numerous hard drives being returned to the manufacturer that are in good working order. This results in a significant waste in terms of cost and time.

### SUMMARY OF THE INVENTION

The present invention describes a system, apparatus and methods for performing diagnostic testing in a RAID environment in response to a failed memory access request. In one embodiment, a RAID controller issues memory access requests to at least one hard drive in a RAID array. In response to detecting a timeout condition with respect to the memory access request, the RAID controller may place the unresponsive hard drive in an inactive state and perform diagnostic testing on the hard drive to determine the cause of the timeout condition.

In one embodiment, the RAID controller may issue diagnostic commands to the hard drive or enclosure to help determine if the timeout occurred due to a hardware failure in the hard drive or some other problem. If the failure was caused by a problem other than a hardware failure in the hard drive, the problem may be fixed by the RAID controller or system administrator without pulling the hard drive from the RAID. This saves time and expense by reducing the number of functioning hard drives that are pulled from a RAID and returned to the manufacturer for testing.

In one embodiment of the invention, the RAID controller will continue to issue memory access requests to the RAID array while the diagnostic tests are being performed. The memory access requests directed at the hard drive being analyzed may still be completed while the hard drive is inactive due to the redundant nature of RAID. If the diagnostic tests reveal that the hard drive is functioning correctly, a rebuild of the hard drive may be initiated prior to changing the state of the hard drive to active. The rebuild process ensures that the data in the hard drive matches the data stored in the redundant disks that have continued to process memory access requests.

### BRIEF DESCRIPTION OF THE DRAWINGS

Reference will be made to embodiments of the invention, examples of which may be illustrated in the accompanying figure. These figures are intended to be illustrative, not limiting. Although the invention is generally described in the context of these embodiments, it should be understood that it is not intended to limit the scope of the invention to these particular embodiments.

FIG. 1 illustrates a typical RAID environment.

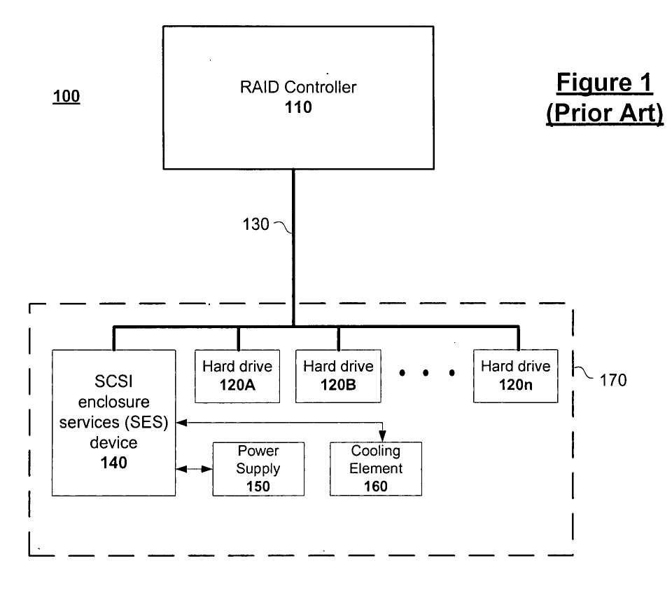

FIG. 2 is a flow chart illustrating a method for performing diagnostic testing in a RAID according to one embodiment of the invention.

FIG. 3 is a flow chart illustrating a method for performing diagnostic testing in a RAID according to one embodiment of the invention.

### DETAILED DESCRIPTION OF THE PREFERRED EMBODIMENTS

Systems, apparatuses, and methods for performing diagnostic testing in a RAID are described. In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be performed in a variety of mediums, including software, hardware, or firmware, or a combination thereof. Accordingly, the flow charts described below are illustrative of specific embodiments of the invention and are meant to avoid obscuring the invention.

Reference in the specification to “one embodiment,” “a preferred embodiment” or “an embodiment” means that a particular feature, structure, characteristic, or function described in connection with the embodiment is included in at least one embodiment of the invention. The appearances of the phrase “in one embodiment” in various places in the specification are not necessarily all referring to the same embodiment.

In one embodiment of the present invention a RAID controller includes hardware, firmware, or software, or a combination thereof to perform diagnostics within a RAID environment when a timeout condition is detected by the RAID controller following a memory access request issued by the RAID controller to a hard drive in the RAID. Examples of memory access requests include read or write commands issued to the hard drive.

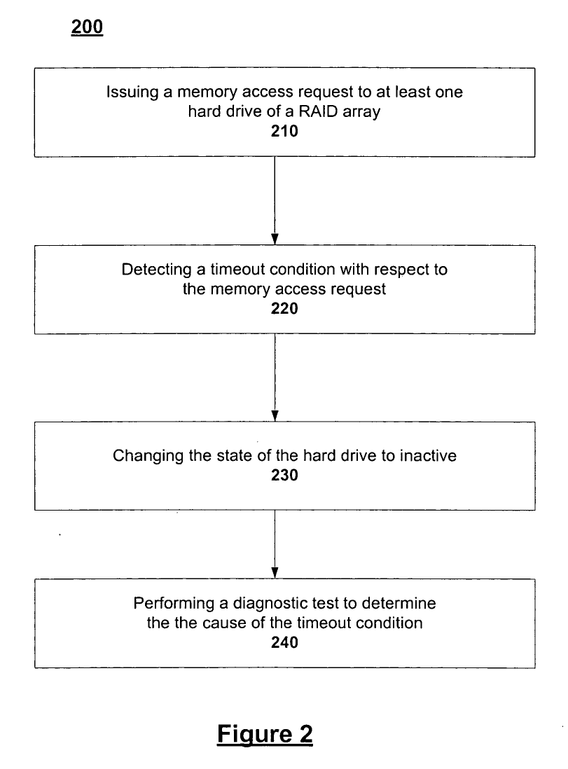

FIG. 2 is a flow chart 200 illustrating a method for performing diagnostic testing in response to a timeout condition according to one embodiment of the present invention. In step 210, a RAID controller issues a memory access request, such as a read or write command, to at least one hard drive in a RAID array. The hard drive(s) has a predetermined amount of time within which to respond to the RAID controller, indicating a successful completion of the memory access request. For example, in the case of a read command, the hard drive responds with the requested data, while a successful write operation may be indicated with an acknowledgement that the write operation was completed by the hard drive.

If the hard drive(s) fails to respond within the predetermined time, the RAID controller detects 220 that a timeout condition has occurred. Detecting the timeout condition informs the RAID controller that a problem has occurred in performing the requested memory access operation. In prior art systems, such a failure would result in marking the hard drive as FAILED, removing the hard drive from the RAID and returning it to the manufacturer to determine why the failure occurred. However, many times, the problem does not result from a permanently failed hard drive. The problem may have been caused by a temporary failure in the hard drive or by some other hardware related problem between the RAID controller and the hard drive. The following are examples of scenarios where hard drives may be marked as FAILED when the hard drive really did not FAIL:
Excessive temperature in the hard drive enclosure which temporarily prevents the hard drive from executing the memory access request;
Excessive vibration in the hard drive mounting which temporarily prevents the hard drive from executing the memory access request;
A snapped or locked up SCSI cable resulting in drive failure due to a timeout condition;
Bad cable conditions giving rise to back-to-back errors like Parity errors that prevent the hard drive from executing the memory access request; and
SCSI chip malfunction, preventing the hard drive from executing the memory access request.
   The examples listed above are only a sample of the scenarios that may have prevented the hard drive from executing the memory access request. One skilled in the art will recognize that there are a number of problems which may have caused the memory access request to fail.

In one embodiment, the RAID controller may change 230 the state of the hard drive to an inactive state in response to detecting the timeout condition. One skilled in the art will recognize that this may be accomplished in a number of ways. For example, the state of each hard drive may be stored in the RAID controller to indicate the drive's status. If a hard drive is functioning properly, it may be stored as being in an active state. When a timeout occurs, the drive state may be changed to inactive. This change in state indicates to the RAID controller that the drive is not working properly and has been taken off-line. In a redundant RAID environment, memory access requests may continue using the redundancy features of the RAID. The RAID controller may issue subsequent memory access requests to other active, redundant hard drives within the RAID, but will refrain from sending subsequent memory access requests to the inactive hard drive until the cause of the timeout condition has been determined and resolved.

The RAID controller may perform 240 one or more diagnostic tests on the hard drive and/or the other elements of the RAID to determine the cause of the timeout condition. As discussed above, the timeout condition may have been caused by a number of different problems, including a hardware failure in the hard drive or cables connecting the hard drive to the RAID controller. There are a number of diagnostic tests that may be performed to rule out some of the causes of the timeout. Using these diagnostics, the RAID controller may be able to detect causes for the timeout that did not involve a hardware failure in the hard drive. Typically, these causes may be corrected by the RAID controller or by a system administrator without removing the hard drive and sending it back to the manufacturer. In one embodiment, the RAID controller may report the results of the diagnostic tests to the system administrator so that the problem may be corrected.

One skilled in the art will recognize that there are a number of ways the RAID controller may perform diagnostic tests. In one embodiment, the RAID controller may interface with a SCSI Enclosure Services (SES) device. An SES device is a combination of hardware and software that is located within a hard drive enclosure. The SES standard defines a set of commands that the SES device may use to monitor and manage non-SCSI elements contained within an enclosure containing one or more SCSI devices (e.g. SCSI hard drives). Examples of non-SCSI elements that may be contained within an enclosure include power supplies, displays and cooling devices. By interfacing with the SES device, the RAID controller may request that the SES device provide information regarding the status of the enclosure and the devices within the enclosure. Using this information, the RAID controller may be able to determine if the timeout condition was caused by excessive vibration, excessive heat, or other problems within the enclosure.

In another embodiment, the RAID controller may utilize drive-self tests (DST). DST is a standard set of tests built into the firmware of industry hard drives. By interfacing with the hard drives, the RAID controller may request that the hard drive perform a self diagnostic using the DST and provide the diagnostic information back to the RAID controller. The redundancy features of the RAID allow the RAID controller to continue to process memory access requests during the DST. The self diagnostic may help determine whether a hard drive has failed, is experiencing a malfunction or whether a hard drive is operating correctly. These diagnostic tests may not be 100% accurate, but will help reduce the number of good hard drives that are pulled out of the system prematurely due to a timeout condition.

One skilled in the art will recognize that there are a number of diagnostic tests that may be used to help detect the cause of a failure. The present invention is not limited to DST and SES. These are only two examples of resources that may be used to perform diagnostics on a hard drive, enclosure, or other component in the RAID environment. The RAID controller may utilize any resources, including specially defined commands and diagnostics that monitor, manage and/or detect the operation, performance and status of devices in the RAID environment.

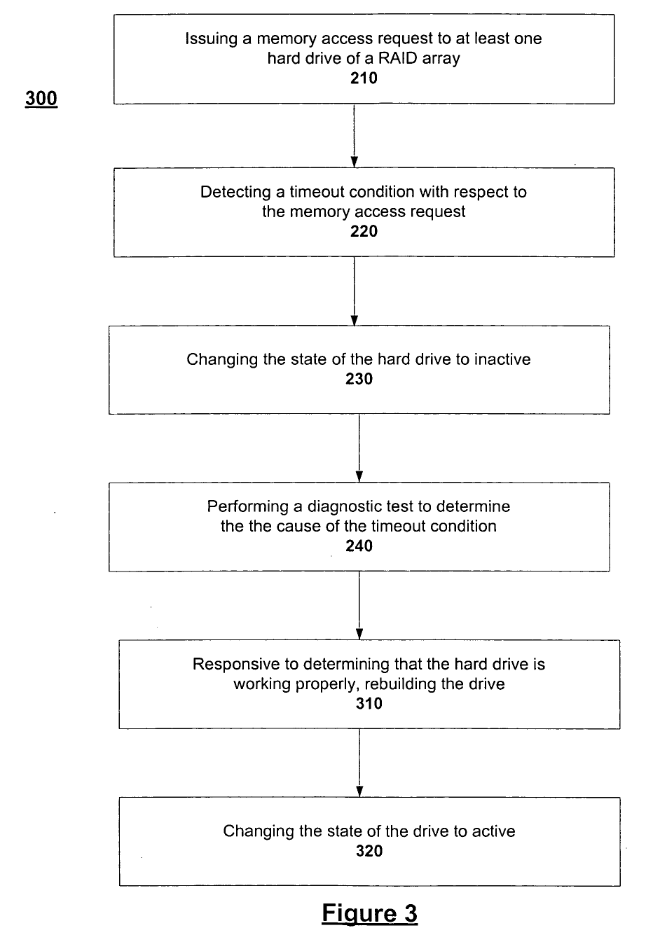

FIG. 3 is a flow chart 300 illustrating a method for handling a timeout condition according to another embodiment of the present invention. The initial steps, 210, 220, 230 and 240, are the same as the method steps found in the method illustrated in FIG. 2. This embodiment describes further steps that may be taken by the RAID controller when the diagnostic test determines that the hard drive has not failed and may be returned to the active state within the RAID.

As discussed above, when the hard drive is taken offline due to encountering a timeout condition, the RAID controller may not issue further memory access requests to the hard drive. However, as discussed above, a RAID may be configured to provide redundancy to the data stored on the hard drive. For example, the RAID may be set up to mirror the data on two drives. Thus, in a redundant RAID setup, the RAID controller may continue to issue memory access requests to the hard drive(s) that maintain the redundant data while the RAID controller performs diagnostic testing on the hard drive and the rest of the RAID environment to determine the cause of the timeout.

Using the results of one or more diagnostics tests, the RAID controller may determine that the hard drive is working properly. If so, the hard drive may be returned to the active state. In other words, the hard drive may be placed back online within the RAID. If however, memory access requests that would have originally been sent to the inactive hard drive are processed by the RAID controller using the redundant drives within the RAID, the data in the inactive hard drive is not up to date. As a result, the hard drive may need to go through a rebuild 310 process before it can be restored to the active state. In one embodiment, a rebuild may be accomplished by copying all of the data from the redundant hard drive(s) to the offline/inactive hard drive. For large hard drives, this rebuild process may take up a lot of time and resources.

In another embodiment, the RAID controller may maintain a log of all the write operations that occur while the hard drive is offline. This log represents all of the changes to the data that the hard drive missed while in the inactive state. Using the log, the RAID controller may significantly reduce the rebuild time by simply issuing the write operations stored in the log to the inactive hard drive before restoring the drive to the active state.

Upon completion of the rebuild process, the inactive hard drive may be restored to the active state by changing 320 the state of the drive to active.

While the present invention has been described with reference to certain embodiments, those skilled in the art will recognize that various modifications may be provided. For example, while the invention has been described as being implemented in a RAID controller, one skilled in the art will recognize that the invention may be implemented in any device capable of interfacing with the RAID and issuing diagnostic commands to the RAID. Variations upon and modifications to the embodiments are provided for by the present invention, which is limited only by the following claims.

What is claimed is:

1. A method for determining whether a hard drive in a Redundant Array of Independent Disks (RAID) has failed, comprising:
issuing a memory access request to the hard drive; and
responsive to the hard drive failing to respond to the command within a predetermined time, issuing at least one diagnostic test to determine why the hard drive failed to respond.

2. The method of claim 1, further comprising:
determining from the at least one diagnostic test that the hard drive is operating correctly; and
performing a rebuild of the hard drive.

3. The method of claim 1, wherein a RAID controller changes the status of the hard drive to inactive for failing to respond to the memory access request within the predetermined time.

4. The method of claim 3 further comprising:
maintaining a log of memory access requests that write data to the RAID while the status of the hard drive is inactive; and
rebuilding the hard drive using the memory access requests stored in the log responsive to the RAID controller determining from the at least one diagnostic test that the hard drive is operating correctly.

5. The method of claim 1, wherein the memory access request is a request to read data from the hard drive.

6. The method of claim 1, wherein the memory access request is a request to write data to the hard drive.

7. The method of claim 1, wherein the at least one diagnostic test involves a RAID controller requesting a SCSI enclosure services (SES) device to issue an SES command.

8. The method of claim 1, wherein the at least one diagnostic test involves a RAID requesting the hard drive to perform a drive self-test (DST).

9. A computer program product embodied on a computer readable medium for determining whether a hard drive in a Redundant Array of Independent Disks (RAID) has failed, the computer program product comprising computer instructions for:
issuing a memory access request to the hard drive; and
responsive to the hard drive failing to respond to the command within a predetermined time, issuing at least one diagnostic test to determine why the hard drive failed to respond.

10. The computer program product of claim 9 further comprising computer instructions for:
determining from the at least one diagnostic test that the hard drive is operating correctly; and
performing a rebuild of the hard drive.

11. The computer program product of claim 9 further comprising computer instructions for changing the status of the hard drive to inactive responsive to a failure of the hard drive to respond to the memory access request within the predetermined time.

12. The computer program product of claim 11 further comprising computer instructions for:
maintaining a log of memory access requests that write data to the RAID while the status of the hard drive is inactive; and
rebuilding the hard drive using the memory access requests stored in the log responsive to the RAID controller determining from the at least one diagnostic test that the hard drive is operating correctly.

13. The computer program product of claim 9, wherein the memory access request is a request to read data from the hard drive.

14. The computer program product of claim 9, wherein the memory access request is a request to write data to the hard drive.

15. The computer program product of claim 9, wherein the at least one diagnostic test involves a RAID controller requesting a SCSI enclosure services (SES) device to issue an SES command.

16. The computer program product of claim 9, wherein the at least one diagnostic test involves a RAID requesting the hard drive to perform a drive self-test (DST).
